(19) United States
(12) Patent Application Publication
(10) Pub. No.: US 2025/0002720 A1
(43) Pub. Date: Jan. 2, 2025

(54) POLYMERIC COMPOSITION AND METHOD FOR PREPARING THE SAME

(71) Applicant: Evonik Operations GmbH, Essen (DE)

(72) Inventors: Chenyu Ye, Shanghai (CN); Kathrin Salwiczek, Recklinghausen (DE); Kathrin Lehmann, Leverkusen (DE); Klaus Hülsmann, Haltern Am See (DE); Urs Welz-Biermann, Allentown, PA (US)

(73) Assignee: Evonik Operations GmbH, Essen (DE)

(21) Appl. No.: 18/708,834

(22) PCT Filed: Nov. 2, 2022
(86) PCT No.: PCT/CN2022/129239

§ 371 Date: May 9, 2024

(30) Foreign Application Priority Data
Nov. 10, 2021 (WO) PCT/CN2021/129775

(51) Int. Cl. C08L 87/00; C08L 75/06; C08L 75/08

(52) U.S. Cl. CPC C08L 87/005; C08L 75/06; C08L 75/08; C08L 2205/03; C08L 2205/08

(57) ABSTRACT

A polymeric composition includes 93 wt. % to 99 wt. % of a mixture containing a polyether block amide and a thermoplastic polyurethane; and 1 wt. % to 7 wt. % of a compatibilizer. The compatibilizer contains at least one or more modified siloxanes and/or one or more condensation products of at least one amino-functional polymer and at least one polyester. A method prepares the polymeric composition by compounding the polyether block amide, the thermoplastic polyurethane, and the compatibilizer to form a blend, and homogenizing the blend under rotation. The polymeric composition produces articles including clothing, sport, sealing, transportation, or structural elements.

### FIELD OF THE PRESENT DISCLOSURE

The present disclosure relates to a polymeric composition and to a method for preparing the same.

### BACKGROUND

Polyamide elastomers have been widely used in sports industry for their unique performances such as low density, excellent anti-fatigue performance, transparency, good flexibility, etc.

Thermoplastic polyurethanes, based on either polyether or polyester, have also been widely utilized for its properties including anti-abrasion. One limitation for thermoplastic polyurethanes to be used in sports equipment is their disadvantage regarding density and stiffness.

It would be of great interest if a blend of polyamide and thermoplastic polyurethane could achieve a combination of advantages of the two constituents while avoiding their disadvantages. To achieve that, good compatibility between polyamide elastomer and TPU is needed. However, it has been widely known that thermoplastic polyurethanes and polyamide elastomers are incompatible.

### SUMMARY OF THE PRESENT DISCLOSURE

It is one objective of the present disclosure to provide a homogenously mixed polyether block amide-thermoplastic polyurethane blend, which can maintain desired performances including high mechanical modulus and a high elongation at break.

Such objective is achieved by a polymeric composition comprising, based on a total weight of the polymeric composition, 93 wt. % to 99 wt. % of a mixture containing a polyether block amide and a thermoplastic polyurethane; and 1 wt. % to 7 wt. % of a compatibilizer, wherein the compatibilizer contains at least one from: one or more modified siloxanes; or one or more condensation products of at least one amino-functional polymer and at least one polyester.

A mixture according to the invention is a blend which contains a polyether block amide and a thermoplastic polyurethane.

According to some embodiments, the mixture contains 5 wt. % to 95 wt. % of the polyether block amide and 95 wt. % to 50 wt. % of the thermoplastic polyurethane, preferably 10 wt. % to 90 wt. % of the polyether block amide and 90 wt. % to 10 wt. % of the thermoplastic polyurethane, more preferably 55 wt. % to 90 wt. % of the polyether block amide and 45 wt. % to 10 wt. % of the thermoplastic polyurethane and even more preferably 60 wt. % to 90 wt. % of the polyether block amide and 40 wt. % to 10 wt. % of the thermoplastic polyurethane, based on a total weight of the mixture.

According to some embodiments, the modified siloxanes include a polyester modified polysiloxane.

According to some embodiments, the polyester modified siloxane is a polysiloxane with one or more terminal ester moieties.

According to some embodiments, the amino-functional polymer is at least one compound selected from the group consisting of amino-functional polyamino acids, amino-functional silicones, polyamidoamines, polyallylamines and poly(N-alkyl) allylamines, polyvinylamines, and polyalkyleneimines. It is preferred that the amino-functional polymer does not contain any epoxy groups.

According to some embodiments, the amino-functional polymer has a number-average molecular weight of 400 g/mol to 600,000 g/mol.

According to some embodiments, the polyester is obtained by ring-opening polymerization of one or more lactones selected from the group consisting of β-propiolactone, β-butyrolactone, γ-butyrolactone, 3,6-dimethyl-1,4-dioxane-2,5-dione, δ-valerolactone, γ-valerolactone, ¿-caprolactone, γ-caprolactone, 4-methylcaprolactone, 2-methyl-caprolactone, 5-hydroxydodecanolactone, 12-hydroxydodecanolactone, 12-hydroxy-9-octadecenoic acid, 12-hydroxyoctadecanoic acid.

According to some embodiments, the polyester has an average molecular weight Mn of 100 to 5,000 g/mol.

According to some embodiments, the polyether comprises, radicals selected from the group consisting of ethylene oxide, propylene oxide, butylene oxide, dodecene oxide, tetradecene oxide, 2,3-dimethyloxirane, cyclopentene oxide, 1,2-epoxypentane, 2-isopropyloxirane, glycidyl methyl ester, glycidyl isopropyl ester, epichlorohydrin, 3-methoxy-2,2-dimethyloxirane, 8-oxabicyclo [5.1.0]octane, 2-pentyloxirane, 2-methyl-3-phenyloxirane, 2,3-epoxypropylbenzene, 2-(4-fluorophenyl) oxirane, and also their pure enantiomer pairs or enantiomer mixtures.

According to some embodiments, the thermoplastic polyurethane is a thermoplastic polyester-polyurethane or a thermoplastic polycarbonate-polyurethane.

According to some embodiments, the thermoplastic polyurethane is a thermoplastic polyether-polyurethane.

According to some embodiments, the polyether block amide is based on a subunit 1, composed of at least one lactam or α,ω-aminocarboxylic acid having 6 to 14 carbon atoms, and on a subunit 2, composed of at least one amino- or hydroxy-terminated polyether having at least 2 carbon atoms per ether oxygen and at least two primary amino or having at least two carbon atoms per ether oxygen and at least two hydroxy groups at chain ends.

Another perspective of the present disclosure is to provide an article prepared from the polymeric composition according to any of the preceding claims.

According to some embodiments, the article is selected from a clothing element, a sport element, a sealing component, a transportation element, or a structural element.

According to some embodiments, the article is a shoe sole.

Another perspective of the present disclosure is to provide a method for preparing a polymeric composition comprising, providing 93 wt. % to 99 wt. % of a mixture containing a polyether block amide and a thermoplastic polyurethane, and 1 wt. % to 7 wt. % of a compatibilizer; compounding the polyether block amide, the thermoplastic polyurethane, and the compatibilizer and forming a blend; homogenizing the blend under rotation; and obtaining a polymeric composition, wherein the compatibilizer contains: one or more modified siloxanes; or one or more condensation products of at least one amino-functional polymer and at least one polyester.

According to some embodiments, the step of compounding the polyether block amide, the thermoplastic polyurethane, and the compatibilizer is conducted by using a twin-screw extruder.

### DETAILED DESCRIPTION

Polyether block amides (PEBA) are block copolymers which are obtained by polycondensation of (oligo) polyamides, in particular acid-regulated polyamides, with alcohol-terminated or amino-terminated polyethers. Acid-regulated polyamides have carboxylic acid end groups in excess. Those skilled in the art refer to the polyamide blocks as hard blocks and the polyether blocks as soft blocks. The production thereof is known in principle. DE2712987A1 (U.S. Pat. No. 4,207,410) describes polyamide elastomers of this type, composed of lactams containing 10-12 carbon atoms, dicarboxylic acids, and polyether diols. The products obtainable according to this document are distinguished by long-lasting flexibility and ductility even at low temperatures, but they are already cloudy to opaque in moldings of moderate layer thickness and, on longer-term storage at room temperature, are conspicuous due to surface deposits having a mildew-like appearance. Similarly, structured polyamide elastomers, assembled from diamines containing 6-20 carbon atoms, aliphatic or aromatic dicarboxylic acids and polyether diols, are known from EP0095893. Distinctive properties are increased heat distortion resistance and flexibility. No data regarding translucency of the moldings and formation of deposits can be gathered from this document.

Polyether block amide and thermoplastic polyurethane are compounded to form a blend. The compounding method can involve a mixer with a strong shear. Preferred mixers include a twin-screw extruder.

[Article Made from the Polymeric Composition]

The compounded PEBA-TPU composition can undergo a shaping process known by those skilled in the art including without limitation to compression-molding, extrusion molding, coextrusion molding, blow molding, 3D blow molding, coextrusion blow molding, coextrusion 3D blow molding, coextrusion suction blow molding, injection molding, pressing, rolling, sheet molding, or an additive manufacturing process such as stereolithography, digital light processing, continuous liquid interface production, selective laser sintering, composite filament fabrication, sheet lamination, selective hear sintering, and fused filament fabrication.

A variety of articles can be prepared from the polymeric composition according to the present disclosure. Without limitation, the article can be a clothing element, a sport element, a sealing component, a transportation element, or a structural element. The article can find applications in the form of articles of clothing, footwears, sport equipment, sealing rings, automotive interior decoration, brakes, airplanes, protective equipment, straps, and components thereof.

Particularly preferably, the article can be a shoe sole as the polymeric composition has a high elongation at break and high mechanical modulus.

### [PEBA]

PEBAs used herein are preferably based on a subunit 1, composed of at least one lactam or α,ω-aminocarboxylic acid having 6 to 14 carbon atoms, and on a subunit 2, composed of at least one amino- or hydroxy-terminated polyether having at least 2 carbon atoms per ether oxygen and at least two primary amino or having at least two carbon atoms per ether oxygen and at least two hydroxy groups at chain ends.

PEBAs are known in the art and result from the polycondensation of polyamide blocks with reactive ends and polyether blocks with reactive ends. It is preferred to obtain PEBA from polyamide blocks with dicarboxylic chain ends. Subunit 1 can result from the condensation of one or more α,ω-aminocarboxylic acids or of one or more lactams in the presence of a dicarboxylic acid, preferably a linear aliphatic dicarboxylic acid. The dicarboxylic acid can contain from 4 to 36 carbon atoms, preferably from 6 to 12 carbon atoms. As examples of dicarboxylic acids mention can be made of 1,4-cyclohexyldicarboxylic acid, butanedioic, adipic, azelaic, suberic, sebacic, dodecanedicarboxylic, octadecanedicarboxylic and terephthalic and isophthalic acids, but also dimerized fatty acids. PEBA and methods for their production are described in US 2006/0189784, for example.

PEBA for the molding composition can be used as prepared or available from the market.

### [Thermoplastic Polyurethane]

Thermoplastic polyurethanes used herein can be a variety of polyurethanes prepared from aliphatic or aromatic polyisocyanate, a polyol based on a polyether, polyester, or polycarbonate linkage, and sometimes a short chain diol (referred to as “chain extender”). Commonly, thermoplastic polyurethanes are categorized as thermoplastic polyester-polyurethanes, thermoplastic polycarbonate-polyurethane and thermoplastic polyether-polyurethane.

Aliphatic polyisocyanate for the thermoplastic polyurethane can be any aliphatic polyisocyanate. Exemplary aliphatic polyisocyanates include methylene bis(4-cyclohexylisocyanate) (HMDI), hexamethylene diisocyanate, and isophorone diisocyanate. Aromatic polyisocyanate can be polyisocyanate with at least two isocyanate groups connected to aromatic ring. Exemplary aromatic polyisocyanates include isomers of toluene diisocyanate (TDI), methylene di(phenylisocyanate) (MDI), and naphthalene diisocyanate.

Polyether polyol can be prepared by reacting alkylene oxide such as ethylene oxide or propylene oxide with diols such as ethylene glycol, propylene glycol, or butanediol. Exemplary polyether diols include polyethylene glycol, polypropylene glycol, polytetramethylene glycol. Polyester polyol can be prepared by a condensation of dicarboxylic acid with excess diol, a reaction between diols and polyesters, e.g., polylactide, or a ring opening of lactone with diols. Exemplary polyester diols include poly(1,4-butylene adipate) diol, polylactide diol, and polycaprolactone diol. Polycarbonate polyol can be prepared by reacting an aliphatic carbonate and one or more diol. Exemplary polycarbonate diols include poly(propylene carbonate) diol, poly(hexamethylene carbonate) diol, or poly(polytetramethylene carbonate) diol.

Thermoplastic polyurethanes can be commercially purchased from various manufacturers, for example, BASF SE, Lubrizol Corporation, and Covestro AG.

The present disclosure is illustrated by way of examples hereinbelow.

### [Compatibilizer]

To make the constituents in the polymeric composition compatible, one or more additives commonly termed “compatibilizer” may be added. According to the present disclosure, the compatibilizer may include a modified polysiloxane and/or a condensation product of at least one amino-functional polymer and at least one polyester. In some cases, the modified polysiloxane and the condensation product could be mixed and added altogether.

The modified polysiloxane may be an alkyl modified polysiloxane or a polyester modified polysiloxane. Preferably, the modified polysiloxane is a polyester modified polysiloxane. Preferably, the polyester modified polysiloxane is a polysiloxane with one or more terminal ester moieties. The polyester modified polysiloxane can be a polyester polysiloxane block copolymer, a polyester polysiloxane graft copolymer. Commercially available products include Tegomer® H-Si 6440P and Tegomer® H-Si 6441P from Evonik Specialty Chemicals (Shanghai) Co., Ltd.

According to the present disclosure, the condensation products of amino-functional polymers and polyester may be obtained by partial or complete reaction of terminal carboxylic groups in polyesters and amino groups in amino-functional polymers. Commercially available products include Tegomer® DA626 from Evonik Specialty Chemicals (Shanghai) Co., Ltd.

The condensation products can be obtained by partial or complete reaction of
A) one or more amino-functional polymers containing at least four amino groups with
B) one or more polyesters of the general formula (I) or (Ia)

T-C(O)—[O-A-C(O)]ₓ—OH (I)

T-O—[C(O)-A-O—]_{y}—Z (Ia)
and
C) one or more polyethers of the general formula (II) or (IIa)

T-C(O)—B—Z (II)

T-O—B—Z (IIa)

where
T is a hydrogen radical and/or an optionally substituted, linear or branched aryl, arylalkyl, alkyl or alkenyl radical having from 1 to 24 carbon atoms,
A is at least one divalent radical selected from the group consisting of linear, branched, cyclic and aromatic hydrocarbons,
Z is at least one radical selected from the group consisting of sulphonic acids, sulphuric acids, phosphonic acids, phosphoric acids, carboxylic acids, isocyanates, epoxides, in particular phosphoric acid and (meth)acrylic acid,
B is a radical of the general formula (III)

(CₗH₂ₗO)ₐ—(CₘH₂ₘO)_{b}—(CₙH₂ₙO)_{c}—(SO)_{d}— (III)
SO═—CH₂—CH(Ph)-O—, wherein Ph=phenyl radical,
a, b, and c are each, independently of one another, from 0 to 100,
d is ≥0, preferably from 1 to 5,
with the proviso that the sum a+b+c is ≥0, preferably from 5 to 35, in particular from 10 to 20, with the proviso that the sum a+b+c+d is >0,
l, m, and n are each, independently of one another, ≥2, preferably from 2 to 4,
x and y are each, independently of one another, ≥2.

The reaction products can be present in the form of the amides and/or the corresponding salts. If the molecule part “Z” has a multiple bond, as can be the case, for example, in the polyethers and the alcohol-initiated polyesters in which the terminal OH group has been esterified with an unsaturated acid such as (meth)acrylic acid bonding is via a Michael addition of the NH function onto the double bond.

Examples of amino-functional polymers are amino-functional polyamino acids such as polylysine from Aldrich Chemical Co.; amino-functional silicones which can be obtained under the trade name Tegomer® ASi 2122 from Evonik Operations GmbH; polyamidoamines which can be obtained under the trade names Polypox®, Aradur® or “Starburst®” as dendrimers from Aldrich Chemical Co.; polyallylamines and poly(N-alkyl) allylamines which can be obtained under the trade name PAA from Nitto Boseki; polyvinylamines which can be obtained under the trade name Lupamin® from BASF AG; polyalkyleneimines, for example polyethyleneimines which can be obtained under the trade names Epomin® (Nippon Shokubai Co., Ltd.), Lupasol (BASF AG); polypropyleneimines which can be obtained under the trade name Astramol® from DSM AG. Further examples of amino-functional polymers are the abovementioned systems crosslinked by means of amine-reactive groups. This linking reaction is, for example, carried out by means of polyfunctional isocyanates, carboxylic acids, (meth)acrylates, and epoxides. Further examples are poly(meth)acrylate polymers comprising dimethylaminopropyl(meth)acrylamide (Evonik Operations GmbH) or dimethylaminoethyl (meth)acrylate (Evonik Operations GmbH) as monomers.

Amino-functional polymers used typically are those having a number-average molecular weight of 400 g/mol to 600 000 g/mol.

Examples of the radical T include but are not limited to alkyl radicals having 1 to 24 carbon atoms, such as the methyl, ethyl, propyl, isopropyl, butyl, isobutyl, tert-butyl, hexyl, isohexyl, octyl, nonyl, isononyl, decyl, dodecyl, hexadecyl and octadecyl radical. Examples of unsubstituted or substituted aryl or arylalkyl radicals having up to 24 carbon atoms are the phenyl, benzyl, tolyl or phenethyl radical.

The polyester groups —[O-A-C(O)]ₓ— and —[C(O)-A-O—]_{y}— contain on average more than two ester groups and have an average molecular weight Mn of 100 to 5000 g/mol. Particular preference is given to a value of Mn=200 to 2000 g/mol.

In one particularly preferred embodiment of the present invention the polyester is obtained by conventional methods by ring-opening polymerization with a starter molecule such as T-CH₂—OH or T-COOH and one or more lactones, such as β-propiolactone, β-butyrolactone, γ-butyrolactone, 3,6-dimethyl-1,4-dioxane-2,5-dione, δ-valerolactone, γ-valerolactone, ε-caprolactone, γ-caprolactone, 4-methylcaprolactone, 2-methylcaprolactone, 5-hydroxydodecanolactone, 12-hydroxydodecanolactone, 12-hydroxy-9-octadecenoic acid, 12-hydroxyoctadecanoic acid.

Starter molecules such as T-COOH and also the fatty alcohols T-CH₂—OH preparable therefrom are preferably the monobasic fatty acids which are customary and known in this field and are based on natural plant or animal fats and oils having 6 to 24 carbon atoms, in particular having 12 to 18 carbon atoms, such as caproic acid, caprylic acid, capric acid, lauric acid, myristic acid, palmitic acid, palmitoleic acid, isostearic acid, stearic acid, oleic acid, linoleic acid, petroselinic acid, elaidic acid, arachidic acid, behenic acid, erucic acid, gadoleic acid, rapeseed oil fatty acid, soybean oil fatty acid, sunflower oil fatty acid, tall oil fatty acid, which can be used alone or in a mixture in the form of their glycerides, methyl or ethyl esters, or as free acids, and also the technical mixtures obtained in the course of pressurized cleavage. Suitable in principle are all fatty acids with a similar chain distribution.

The unsaturated content of these fatty acids or fatty acid esters is adjusted, insofar as is necessary, by means of the known catalytic hydrogenation methods to a desired iodine number or is achieved by blending fully hydrogenated with unhydrogenated fatty components.

The iodine number, as an index of the average degree of saturation of a fatty acid, is the amount of iodine absorbed by 100 g of the compound in saturating the double bonds.

Not only the fatty acids but also the resultant alcohols can be modified by addition reaction with alkylene oxides, especially ethylene oxide and/or styrene oxide.

Examples of the polyether radicals of B are alkylene oxides which include but are not limited to: ethylene oxide, propylene oxide, butylene oxide, styrene oxide, dodecene oxide, tetra-decene oxide, 2,3-dimethyloxirane, cyclopentene oxide, 1,2-epoxypentane, 2-isopropyloxirane, glycidyl methyl ester, glycidyl isopropyl ester, epichlorohydrin, 3-methoxy-2,2-dimethyloxirane, 8-oxabicyclo [5.1.0]octane, 2-pentyloxirane, 2-methyl-3-phenyloxirane, 2,3-epoxypropylbenzene, 2-(4-fluorophenyl) oxirane, tetrahydrofuran, and also their pure enantiomer pairs or enantiomer mixtures.

The group Z may be constructed from adducts which include but are not limited to carboxylic anhydrides such as succinic anhydride, maleic anhydride, or phthalic anhydride.

The weight ratio of polyester to polyether in the comp is between 50:1 and 1:9, preferably between 40:1 and 1:5, and more preferably between 30:1 and 1:1.

### Examples

The following materials were employed in the working and comparative examples:

Vestamid® E55-S3 from Evonik Operations GmbH is a low-density polyether block amide (PEBA) block polymer, containing segments of PA 12 and polyether. Vestamid® E55-S3 has a Shore D hardness of 55.

Elastollan® 1195A10 from BASF Polyurethanes GmbH is a transparent thermoplastic polyether-polyurethane based on methylene diphenyl diisocyanate, polytetramethylene glycol with number average molecular weight (Mn) of about 1,000 g/mol, and 1,4-butanediol as chain extender. It has a Shore A hardness of 95.

Covestro TPU Desmopan® 3695 AU from Covestro AG is a transparent thermoplastic polyester-polyurethane. It has a Shore A hardness of 95.

Tegomer® H-Si 6441P from Evonik Operations GmbH is a polyester modified siloxane delivered in pellet form with excellent compatibility in thermoplastic resins.

Tegopren® 6846 from Evonik Operations GmbH is an alkyl modified siloxane.

Tegomer® DA 626 from Evonik Operations GmbH is a condensation product of polyesters and amino-functional polymers used mainly as a polymeric dispersing agent. In the examples, a masterbatch (hereinafter “Masterbatch T”) containing 50 wt. % of Tegomer® DA 626 and 50 wt. % of polyamide 12 were used.

Tensile modulus of elasticity, tensile stress at break, and elongation at break were determined by Zwick Z020 materials testing system according to ISO 527, on ISO tensile specimens, type 1A, 170 mm×10 mm×4 mm at a temperature (23±2° C.), relative humidity (50±10) %.

The polyether block amide (PEBA), the thermoplastic polyurethane (TPU), and the compatibilizer were mixed using a Coperion ZSK-26 cm co-rotating twin screw extruder, discharged, pelletized to obtain compounded PEBA-TPU pellets. The temperature was set to 220° C. and a screw rotation speed was set to 250 rounds per minute (RPM). The compounding was conducted with a throughput of 20 kg/h. Specific energy input was 0.154-0.163 kWh/kg. Torque was 57-62%. As Masterbatch T (wt. %) is a masterbatch of 50 wt. % concentration of Tegomer® DA 626, its dosage was doubled to be comparable to the other two compatibilizers. Accordingly, the actual weight percentage of compatibilizer is half of that of Masterbatch T in Examples 5, 10-11, 18-19, and 20-29.

The compounded PEBA-TPU compositions in pellet form were processed on an injection molding machine Engel VC 650/200 (melting temperature: 220° C., molding temperature: 35° C.) to prepare samples for testing. Injection pressure and holding pressure were 400 bar and 600 bar, respectively.

The mechanical test results of samples made from compounded PEBA-TPU composition are shown in Tables 1 through 5. C1-C2, C10, C12, C13-C14, C22, and C24 are comparative examples, while the rest are working examples.

TABLE 1
Test results of samples made from
compounded PEBA-TPU compositions

| | C1 | C2 | E3 | E4 | E7 | E8 |
|---|---|---|---|---|---|---|
| Materials | | | | | | |
| Vestamid ® | 85 | 85 | 83 | 83 | 81 | 81 |
| E55-S3 (wt. %) | | | | | | |
| Elastollan ® | 15 | — | 15 | — | 15 | — |
| 1195A10 (wt. %) | | | | | | |
| Desmopan ® | — | 15 | — | 15 | — | 15 |
| 3695 DU (wt. %) | | | | | | |
| Tegomer ® | — | — | 2 | 2 | — | — |
| H-Si 6441P (wt. %) | | | | | | |
| Masterbatch T (wt. %) | — | — | — | — | 4 | 4 |
| Properties | | | | | | |
| Modulus (MPa) | 166 | 180 | 163 | 165 | 135 | 150 |
| Stress at break (MPa) | 41 | 39 | 45 | 46 | 39 | 47 |
| Elongation at break (%) | 477 | 436 | 539 | 534 | 480 | 561 |

TABLE 2
Test results of samples made from
compounded PEBA-TPU compositions

| | | | |
|---|---|---|---|
| E9 | C10 | E11 | C12 |

Materials

| | | | | |
|---|---|---|---|---|
| Vestamid ® E55-S3 (wt. %) | 78 | 69 | 78 | 69 |
| Elastollan ® 1195A10 (wt. %) | 12 | 11 | — | — |
| Desmopan ® 3695 DU (wt. %) | — | — | 12 | 11 |
| Masterbatch T (wt. %) | 10 | 20 | 10 | 20 |

Properties

| | | | | |
|---|---|---|---|---|
| Modulus (MPa) | 142 | 163 | 184 | 176 |
| Stress at break (MPa) | 37 | 30 | 39 | 20 |
| Elongation at break (%) | 493 | 423 | 514 | 324 |

TABLE 3
Test results of samples made from
compounded PEBA-TPU compositions

| | C13 | C14 | E15 | E16 | E17 | E18 | E19 |
|---|---|---|---|---|---|---|---|
| Materials | | | | | | | |
| Vestamid ® | 15 | 15 | 15 | 15 | 15 | 15 | 15 |
| E55-S3 (wt. %) | | | | | | | |
| Elastollan ® | 85 | — | 83 | — | 83 | — | 81 |
| 1195A10 (wt. %) | | | | | | | |
| Desmopan ® | — | 85 | — | 83 | — | 83 | — |
| 3695 DU (wt. %) | | | | | | | |
| Tegomer ® | — | — | 2 | 2 | — | — | — |
| H-Si 6441P (wt. %) | | | | | | | |
| Tegopren ® | — | — | — | — | 2 | 2 | — |
| 6846 (wt. %) | | | | | | | |
| Masterbatch T (wt. %) | — | — | — | — | — | — | 4 |
| Properties | | | | | | | |
| Modulus (MPa) | 62 | 121 | 57 | 109 | 61 | 115 | 58 |
| Stress at break (MPa) | 51 | 46 | 51 | 35 | 55 | 48 | 50 |
| Elongation at | 589 | 603 | 625 | 618 | 617 | 641 | 621 |
| break (%) | | | | | | | |

TABLE 4
Test results of samples made from
compounded PEBA-TPU compositions

| | | | |
|---|---|---|---|
| E21 | C22 | E23 | C24 |

Materials

| | | | | |
|---|---|---|---|---|
| Vestamid ® E55-S3 (wt. %) | 12 | 11 | 12 | 11 |
| Elastollan ® 1195A10 (wt. %) | 78 | 69 | — | — |
| Desmopan ® 3695 DU (wt. %) | — | — | 78 | 69 |
| Masterbatch T (wt. %) | 10 | 20 | 10 | 20 |

Properties

| | | | | |
|---|---|---|---|---|
| Modulus (MPa) | 29 | 29 | 58 | 48 |
| Stress at break (MPa) | 27 | 13 | 21 | 8 |
| Elongation at break (%) | 473 | 275 | 382 | 74 |

Elongation at break of compounded PEBA-TPU composition increases when a minor amount of compatibilizer is added, as shown in the examples. Whilst not wishing to be bound by any particular theory, this improvement may be the results of improved compatibility. When the amount of Masterbatch T reaches 10 wt. %, elongation decreases.

Various aspects and embodiments are possible. Some of those aspects and embodiments are described herein. After reading this specification, those skilled in the art will appreciate that those aspects and embodiments are only illustrative and do not limit the scope of the present disclosure.

1. A polymeric composition, comprising:
based on a total weight of the polymeric composition,
93 wt. % to 99 wt. % of a mixture containing a polyether block amide and a thermoplastic polyurethane; and
1 wt. % to 7 wt. % of a compatibilizer,
wherein the compatibilizer contains at least one selected from the group consisting of one or more modified siloxanes and one or more condensation products of at least one amino-functional polymer, at least one polyester, and at least one polyether.

2. The polymeric composition according to claim 1, wherein the mixture contains 5 wt. % to 95 wt. % of the polyether block amide and 95 wt. % to 5 wt. % of the thermoplastic polyurethane, based on a total weight of the mixture.

3. The polymeric composition according to claim 1, wherein the compatibilizer contains one or more modified siloxanes and the one or more modified siloxanes include a polyester modified polysiloxane.

4. The polymeric composition according to claim 3, wherein the polyester modified siloxane is a polysiloxane with one or more terminal ester moieties.

5. The polymeric composition according to claim 1, wherein the compatibilizer contains one or more condensation products and the amino-functional polymer is at least one compound selected from the group consisting of amino-functional polyamino acids, amino-functional silicones, polyamidoamines, polyallylamines and poly(N-alkyl) allylamines, polyvinylamines, and polyalkyleneimines.

6. The polymeric composition according to claim 1, wherein the compatibilizer contains one or more condensation products and the amino-functional polymer does not contain any epoxy groups.

7. The polymeric composition according to claim 1, wherein the compatibilizer contains one or more condensation products and the amino-functional polymer has a number-average molecular weight of 400 g/mol to 600,000 g/mol.

8. The polymeric composition according to claim 1, wherein the compatibilizer contains one or more condensation products and the polyester is obtained by ring-opening polymerization of one or more lactones selected from the group consisting of β-propiolactone, β-butyrolactone, γ-butyrolactone, 3,6-dimethyl-1,4-dioxane-2,5-dione, δ-valerolactone, γ-valerolactone, ε-caprolactone, γ-caprolactone, 4-methylcaprolactone, 2-methyl-caprolactone, 5-hydroxydodecanolactone, 12-hydroxydodecanolactone, 12-hydroxy-9-octadecenoic acid, and 12-hydroxyoctadecanoic acid.

9. The polymeric composition according to claim 1, wherein the compatibilizer contains one or more condensation products and the polyester has an average molecular weight Mn of 100 to 5,000 g/mol.

10. The polymeric composition according to claim 1, wherein the compatibilizer contains one or more condensation products and the polyether comprises radicals selected from the group consisting of ethylene oxide, propylene oxide, butylene oxide, dodecene oxide, tetradecene oxide, 2,3-dimethyloxirane, cyclopentene oxide, 1,2-epoxypentane, 2-isopropyloxirane, glycidyl methyl ester, glycidyl isopropyl ester, epichlorohydrin, 3-methoxy-2,2-dimethyloxirane, 8-oxabicyclo [5.1.0]octane, 2-pentyloxirane, 2-methyl-3-phenyloxirane, 2,3-epoxypropylbenzene, 2-(4-fluorophenyl) oxirane, and their pure enantiomer pairs and enantiomer mixtures.

11. The polymeric composition according to claim 1, wherein the thermoplastic polyurethane is a thermoplastic polyester-polyurethane or a thermoplastic polycarbonate-polyurethane.

12. The polymeric composition according to claim 1, wherein the thermoplastic polyurethane is a thermoplastic polyether-polyurethane.

13. The polymeric composition according to claim 1, wherein the polyether block amide is based on a subunit 1, composed of comprising at least one selected from the group consisting of lactam and α,ω-aminocarboxylic acid having 6 to 14 carbon atoms, and on a subunit 2, comprising at least one selected from the group consisting of amino- or hydroxy-terminated polyether having at least 2 carbon atoms per ether oxygen and at least two primary amino and amino- or hydroxy-terminated polyether having at least two carbon atoms per ether oxygen and at least two hydroxy groups at chain ends.

14. An article prepared from the polymeric composition according to claim 1.

15. The article according to claim 14, wherein the article is a clothing element, a sport element, a sealing component, a transportation element, or a structural element.

16. The article according to claim 14, wherein the article is a shoe sole.

17. A method for preparing a polymeric composition, comprising:
providing 93 wt. % to 99 wt. % of a mixture containing a polyether block amide and a thermoplastic polyurethane, and 1 wt. % to 7 wt. % of a compatibilizer;
compounding the polyether block amide, the thermoplastic polyurethane, and the compatibilizer and forming a blend;
homogenizing the blend under rotation; and
obtaining a polymeric composition,
wherein the compatibilizer contains one or more modified siloxanes or one or more condensation products of at least one amino-functional polymer and at least one polyester.

18. The method according to claim 17, wherein compounding the polyether block amide, the thermoplastic polyurethane, and the compatibilizer is conducted by using a twin-screw extruder.
